(19) United States
(12) Patent Application Publication
(10) Pub. No.: US 2011/0240199 A1
(43) Pub. Date: Oct. 6, 2011

(54) PNEUMATIC TIRE FOR VEHICLES

(75) Inventors: WOLFGANG REESE, PEINE (DE); KAY BERNKURTH, GARBSEN (DE); MARTIN FRANCKE, GARBSEN (DE); LUDWIG REINHARD, BAD MUENDER (DE)

(73) Assignee: CONTINENTAL REIFEN DEUTSCHLAND GMBH, HANOVER (DE)

(21) Appl. No.: 13/161,712

(22) Filed: Jun. 16, 2011

Related U.S. Application Data
(63) Continuation of application No. PCT/EP2009/064602, filed on Nov. 4, 2009.

(30) Foreign Application Priority Data
Feb. 19, 2009 (DE) 10 2009 003 511.7
May 13, 2009 (DE) 10 2009 025 793.4

(51) Int. Cl. B60C 9/18

(52) U.S. Cl. 152/527; 152/537

(57) ABSTRACT

A pneumatic tire for vehicles has a belt and a reinforcing material layer embedded in at least one rubber mixture. The belt is made of a material that is selected from the group of steel, aramid, carbon fiber, natural fiber, magnesium, and magnesium compounds. The reinforcing material layer is a single-ply or multiple-ply layer that is oriented at an angle between 0 degrees and 5 degrees to the circumferential direction, and is made of at least one polyester thread and/or polyester cord.

### CROSS-REFERENCE TO RELATED APPLICATION

This application is a continuation, under 35 U.S.C. §120, of copending international application No. PCT/EP2009/064602, filed Nov. 4, 2009, which designated the United States; this application also claims the priority, under 35 U.S.C. §119, of German patent applications Nos. DE 10 2009 003 511.7, filed Feb. 19, 2009, and DE 10 2009 025 793.4, filed May 13, 2009; the prior applications are herewith incorporated by reference in their entirety.

### BACKGROUND OF THE INVENTION

### Field of the Invention

The invention lies in the field of pneumatic vehicle tires and pertains, more particularly, to a pneumatic vehicle tire having a belt and having a strength element ply embedded into at least one rubber mixture.

Strength elements for reinforcing various elastomeric articles of manufacture are well known. Take pneumatic vehicle tires, for example, where it is known to use a belt bandage which has a single-ply or multiple-ply construction, covers the belt edges and contains strength elements, which extend in a parallel manner and essentially in the circumferential direction, in the form of cords embedded in the gum. This belt bandage has the purpose, particularly in high-speed use, to prevent the tire from undergoing a rise due to the centrifugal forces arising in operation.

In the course of tire production, the bandage is applied in the form of plies, strips or individual cords with strength elements embedded into an unvulcanized mixture of rubber which are wound or spooled onto the belt. The strength elements are embedded into rubber by a sheet of substantially parallel thread-shaped strength elements, which are generally pretreated thermally and/or with impregnation for better adherence to the embedding gum in a manner known to one skilled in the art, passing in the longitudinal direction through a calender or an extruder for sheathing with the rubber mixture. In the course of shaping with existing apparatus and the vulcanization of the tire, the tire generally expands in the shoulder region, due to the rise, by up to 2% and in the center region by up to 4% compared with the unvulcanized green tire when the green tire is wound on a flat drum. With more recent building drums, elongation during tire production is required to be still lower at about not more than 2%. The rise is lower with more recent apparatus. A further problem is the shrinkage behavior of the particular cord material at elevated temperature. A lower shrinkage behavior effectuates a higher dimensional stability for the vehicle tire and thus better flatspotting.

The cords of the bandage shall allow a sufficient rise in shaping and in the vulcanization mold during tire production in order that the tire may be precisely formed, and they shall ensure, after the tire is finished, good high-speed utility, i.e., good dimensional stability in operation. To meet these requirements, the cords should be extendable with moderate force up to a strain of about 3-4% and require a very much higher force to be extendable to a higher strain.

Conveyor belts are endless belts which contain as an essential feature a strength element usually composed of woven fabric plies, constructed from identical and/or different cord materials. The woven cord fabric is exposed to severe mechanical stresses even in the course of the manufacture of the conveyor belts. The cord fabric is frictionized or doughed in order that it may be rendered adherence-friendly to the coating layer and thereafter both-sidedly coated in a calender, repeatedly doubled and finally calendered with the top layer. Conveyor belts generally have to be able to withstand appreciable stresses due to the high transportation rates, which is why there is typically a need for substantial use of a strength element.

Flat belts have a traction element formed from a strength element ply consisting of cabled cord threads. The cord threads embedded in a rubber matrix are protected by one or two rubberized wrapping fabrics. The cord is intended to enable the flat belt to transmit high forces at low strains. This also holds for flexible woven-fabric tubes which are exposed to high internal and external pressures and therefore are reinforced by a suitable strength element ply composed of a woven cord fabric or of individual cord threads. When incorporating cord into the flexible woven-fabric tubes, it is important to apply the cord threads at certain angles in order to prevent lengthening and thinning or widening and shortening.

Air bellows constructed from one or more rubber matrices similarly need reinforcement by a strength element ply constructed from cords, to partially absorb the stresses due to compression, traction or shearing. The strength element ply constructed from cords must again provide high transmission of force at very low strains.

The following published documents represent pertinent prior art:

U.S. Pat. No. 7,252,129 B2 describes a hybrid cord consisting of aramid fibers and a further fiber selected from the group consisting of polyester, nylon and rayon. The hybrid cord ensures lower separation of the individual threads of the strength element ply.

U.S. Pat. No. 7,308,923 B2 and its counterpart European patent EP 1 703 005 B1 describe a dip-coated hybrid cord comprising a rayon yarn and a lyocell yarn and being notable for good fatigue resistance.

The disclosure of vehicle tires having a strength element cord having a low twisting rate of 40 to 100 t/m is known from published UK patent application GB 2 139 574 A. This is said to improve the rolling resistance of high-speed tires.

U.S. Pat. No. 4,724,881 and its counterpart UK patent application GB 2 172 251 A describes a vehicle tire having a strength element cord consisting of monofilament yarn, wherein the monofilament has a fineness of at least 250 dtex and wherein the monofilament has not been twisted.

U.S. Pat. Nos. 6,016,858 and 6,082,423 each describes lightweight tires having optimized rolling resistance behavior with an “overlay” of cords selected from the group consisting of aramid, rayon, PEN, PET and PVA. The belts of the respective tires consist of fiberglass (U.S. Pat. No. '858) or of rayon (U.S. Pat. No. '423).

U.S. Pat. No. 5,968,295 and its counterpart European patent application EP 0 715 971 A2 describe a pneumatic vehicle tire having a so-called 0° belt ply consisting of polyethylene terephthalate or nylon fibers. The twist here is not more than 300 t/m.

### SUMMARY OF THE INVENTION

It is accordingly an object of the invention to provide a pneumatic tire which overcomes a variety of disadvantages of the heretofore-known devices and methods of this general type and which provides for a pneumatic vehicle tire that includes a strength element ply which is constructed from yarns and/or cords and which have a lower shrinkage behavior and a higher degree of dimensional stability.

With the foregoing and other objects in view there is provided, in accordance with the invention, a pneumatic vehicle tire, comprising:

a belt formed of a material selected from the group consisting of steel, aramid, carbon fibers, natural fibers, magnesium, and magnesium compounds;

a strength element ply embedded into at least one rubber mixture, said strength element ply being a single-ply or multiple-ply disposed at an angle between 0° and 5° relative to a circumferential direction of the tire, and said strength element ply consisting of one or more polyester materials selected from the group consisting of at least one polyester yarn and polyester cord.

In other words, we have found that the objects of the present invention are most favorably achieved when the pneumatic vehicle tire having a belt and having a strength element ply embedded into at least a rubber mixture is characterized in that the belt consists of a material selected from the group consisting of steel, aramid, carbon fibers, natural fibers, magnesium and magnesium compounds, and in that the strength element ply is single-ply or multiple-ply at an angle between 0° and 5° to the circumferential direction and consists of at least one polyester yarn and/or polyester cord.

Surprisingly, such a strength element ply is found to have a distinctly improved shrinkage behavior and a distinctly improved dimensional stability in a pneumatic vehicle tire whose belt material is selected from the group consisting of steel, aramid, carbon fibers, natural fibers, magnesium and magnesium compounds.

The use of polyamide yarns and cords in a strength element ply, as it is known in the art, has a low modulus of elasticity, and exhibits the disadvantage of high hot-shrinking in the final tire.

When aramid yarns and/or cords are used during tire building, on the other hand, the strength element plies thus constructed prove to be disadvantageous in that their extensibility is too low, so that the green tire is only insufficiently formable and as a result only poor tire uniformity is obtainable.

In contrast with the prior art, the pneumatic vehicle tire according to the present invention with a strength element ply of polyester yarn and/or polyester cord does not exhibit these above-mentioned disadvantages. Moreover, the use of a strength element ply polyester yarn and/or polyester cord is distinctly less costly than the use of the hitherto customary aramid yarns or cords and/or the use of hybrid cords.

Furthermore, the strength element ply is configured to be single-ply or multiple-ply, preferably single-ply, at an angle between 0° and 5° to the circumferential direction. Configured in this context means that the strength element ply is wound in the circumferential direction to be single-ply or multiple-ply, preferably single-ply.

The belt of the present invention pneumatic vehicle tire consists of a material selected from the group consisting of steel, aramid, carbon fibers, natural fibers, magnesium and magnesium compounds, of which steel is preferred.

It will be found to be advantageous for the polyester yarn and/or the polyester cord to be an HMLS polyester yarn and/or an HMLS polyester cord (HMLS—High Modulus Low Shrinkage) or an HMHS polyester yard and/or an HMHS polyester cord (HMHS—High Modulus High Shrinkage).

Preference is given to using an HMLS polyester yarn and/or an HMLS polyester cord, and the dipped polyester yarn and/or the dipped HMLS polyester cord should have an ASTM D 855 shrinkage at 180° C. of 2%±1.0% for use in a tire.

Pneumatic vehicle tires and industrial rubber articles frequently utilize not the pure yarn but usually a cord. A cord, in contradistinction to a yarn, consists of at least two or more yarns twisted together.

The polyester of the polyester yarn and/or polyester cord is advantageously selected from the group consisting of polyethylene terephthalate (PET) and/or polyethylene naphthalate (PEN) and/or polybutylene terephthalate (PBT) and/or polycarbonate (PC).

To ensure reliable adherence of textile strength elements to the rubber, it is advantageous to provide the polyester yarn and/or the polyester cord with an adhesive impregnation, for example with an RFL dip in a 1-bath or 2-bath process.

It is further advantageous for the polyester cord to have a fineness in the range from 2000 to 5000 dtex and preferably in the range from 3000 to 4000 dtex, and/or for the polyester yarn to have a fineness in the range from 1000 to 1670 dtex and preferably in the range from 1100 to 1440 dtex. Those of skill in the pertinent art readily understand that the particulars for cords relate to the overall dtex.

It is advantageous when the polyester yarn, preferably present as dipped cords, i.e., already provided with an adhesive impregnation, is end-twisted at a twisting rate in the range from 250 to 500 t/m and preferably in the range from 370 to 430 t/m, and has an ASTM D 855 elongation at 45 N between 2.0 and 5.5%, preferably between 2.7 and 5.0% and more preferably between 3.2 and 4.5%.

It has been determined that these material characteristics ensure good results with regard to shrinkage behavior and dimensional stability.

When the above-described strength element ply embedded into at least a rubber mixture is used in a pneumatic vehicle tire, preferably as belt bandage and/or as bead reinforcer, the tire will have particularly good high-speed utility and flatspotting is substantially reduced. For this, the number of ends in the cord in a particular embodiment is in the range from 80 to 125 epdm and preferably in the range from 90 to 110 epdm.

When the above-described strength element ply is used as a bead reinforcer in a pneumatic vehicle tire, the advantage is that this strength element has a higher modulus than hitherto customarily used polyamide strength element plies, and there is likewise a cost advantage.

These advantages are also achieved when the above-described strength element ply is used in the manufacture of further elastomeric articles of manufacture, such as conveyor belts, flat belts, flexible woven-fabric tubes and air bellows.

Exemplary embodiments and further advantages of the present invention are more particularly elucidated in connection with table 1 which follows:

TABLE 1

| | Polyamide | Polyamide | Polyester | Polyester |
|---|---|---|---|---|
| | cord | cord | cord | cord |
| | (nylon-6,6) | (nylon-6,6) | (PET) | (PET) |
| | 940 × 2 | 940 × 2 | 1440 × 2 | 1440 × 2 |
| | dtex | dtex | dtex | dtex |
| | 80 epdm | 80 epdm | 105 epdm | 105 epdm |
| | single ply | two ply | single ply | two ply |
| ASTM D 855 force | 35 N/cm | 70 N/cm | 90 N/cm | 180 N/cm |
| at 1% strain | | | | |
| ASTM D 855 force | 70 N/cm | 140 N/cm | 200 N/cm | 400 N/cm |
| at 3% strain | | | | |
| ASTM D 855 shrinkage | 5.0 | 5.0 | 2.0 | 2.0 |
| at 180° C. (%) | | | | |
| Residual shrinkage (%) | 3.0 | 3.0 | 1.8 | 1.8 |

The reported forces are unambiguously defined via the dependence on the strain. Shrinkage is defined via the dependence on the counter-force. The reported values are laboratory data at a preload of 0.5 cN/tex, i.e., 940×2 results in a preload of 94 cN and 1440×2 in a preload of 144 cN. The higher modulus of the polyester cord means that the number of plies of the strength element can be reduced by about 50%, which also reduces the amount of rubber mixture into which the strength element ply is embedded. This results in a better rolling resistance behavior of the pneumatic vehicle tire and hence in lower fuel consumption.

The distinctly improved shrinkage behavior provides enhanced dimensional stability in the pneumatic vehicle tire.

1. A pneumatic vehicle tire, comprising:
a belt formed of a material selected from the group consisting of steel, aramid, carbon fibers, natural fibers, magnesium, and magnesium compounds;
a strength element ply embedded into at least one rubber mixture, said strength element ply being a single-ply or multiple-ply disposed at an angle between 0° and 5° relative to a circumferential direction of the tire, and said strength element ply consisting of one or more polyester materials selected from the group consisting of at least one polyester yarn and polyester cord.

2. The pneumatic vehicle tire according to claim 1, wherein said belt consists of steel.

3. The pneumatic vehicle tire according to claim 1, wherein said strength element ply is a single-ply assembly.

4. The pneumatic vehicle tire according to claim 1, wherein said polyester is at least one polyester material selected from the group consisting of polyethylene terephthalate (PET), polyethylene naphthalate (PEN), polybutylene terephthalate (PBT), and polycarbonate (PC).

5. The pneumatic vehicle tire according to claim 1, wherein said polyester cord has a fineness in a range from 2000 to 5000 dtex.

6. The pneumatic vehicle tire according to claim 5, wherein said polyester cord has a fineness in a range from 3000 to 4000 dtex.

7. The pneumatic vehicle tire according to claim 1, wherein said polyester yarn has a fineness in a range from 1000 to 1670 dtex.

8. The pneumatic vehicle tire according to claim 7, wherein said polyester yarn has a fineness in a range from 1100 to 1440 dtex.

9. The pneumatic vehicle tire according to claim 1, wherein said polyester yarn and/or said polyester cord is end-twisted at a twisting rate in a range from 250 to 500 t/m.

10. The pneumatic vehicle tire according to claim 9, wherein said polyester yarn and/or said polyester cord is end-twisted at a twisting rate in a range from 300 to 430 t/m.

11. The pneumatic vehicle tire according to claim 1, wherein said polyester yarn and/or said polyester cord has an ASTM D 855 elongation at 45 N between 2.0 and 5.5%.

12. The pneumatic vehicle tire according to claim 11, wherein said ASTM D 855 elongation at 45 N lies between 2.7 and 5.0%.

13. The pneumatic vehicle tire according to claim 11, wherein said ASTM D 855 elongation at 45 N lies between 3.2 and 4.5%.

14. The pneumatic vehicle tire according to claim 1, wherein said strength element ply embedded into said rubber mixture is a belt bandage.

15. The pneumatic vehicle tire according to claim 14, wherein a number of ends within said belt bandage lies in a range from 80 to 125 epdm.

16. The pneumatic vehicle tire according to claim 15, wherein the number of ends within the belt bandage lies in a range from 90 to 110 epdm.

17. The pneumatic vehicle tire according to claim 1, wherein said strength element ply embedded into said rubber mixture is a bead reinforcer.

18. The pneumatic vehicle tire according to claim 17, wherein a number of ends within said bead reinforcer lies in a range from 80 to 125 epdm.

19. The pneumatic vehicle tire according to claim 18, wherein the number of ends within said bead reinforcer lies in a range from 90 to 110 epdm.
